(19) United States
(12) Patent Application Publication
(10) Pub. No.: US 2008/0280063 A1
(43) Pub. Date: Nov. 13, 2008

(54) Method of coloring patterns or texts on a surface of an aluminum alloy material

(76) Inventor: Shih-Chieh Chang, Taichung County (TW)

Correspondence Address: SHIH-CHIEH, CHANG, P.O. Box 44-2049, Taipei, 10668, TW

(21) Appl. No.: 11/798,202

(22) Filed: May 11, 2007

(51) Int. Cl. B05D 7/14

(52) U.S. Cl. 427/532

(57) ABSTRACT

In a method of coloring patterns or texts on a surface of an aluminum alloy material, an insulating layer is formed on the surface of the aluminum alloy material, and then the patterns or texts, which are partially insulated and partially conductive, are formed by way of laser engraving. Next, the conductive portion of the patterns or texts is treated by way of electro-deposition coating so that a cladding layer having a color different from that of the aluminum alloy material may be formed on the patterns or texts, different colors may appear, and the flatness of the surface may be kept.

### BACKGROUND OF THE INVENTION

(1) Field of the Invention

The invention relates to a method of coloring patterns or texts on a surface of an aluminum alloy material, wherein the patterns or texts having partially insulating and partially conductive portions are formed by way of laser engraving, and then the conductive portions of the patterns or texts are treated by way of electro-deposition coating so that the patterns or texts have colors different from that of the aluminum alloy material.

(2) Description of the Prior Art

Workpieces, such as bicycle components, vehicle wheel rims, optical components and aerospace components, must have the light-weighted property and the high intensity, so they are usually made of an aluminum alloy, a magnesium alloy or a titanium alloy. In order to make the workpiece withstand wear, erosion and the high voltage, an anode treatment is performed on the workpiece to form an oxide film on a surface of the workpiece. The oxide film can withstand the oxidation and make the workpiece be insulated. The oxide film coated on the surface of the workpiece may have various colors due to different metals of plated layers so that the color variation and quality of the workpiece may be enhanced. However, the patterns or texts only may be formed on the surface of the workpiece in a depressed manner by way of laser engraving, or printed on the surface of the workpiece. Alternatively, a label on which the patterns are printed may be attached to the surface of the workpiece.

FIGS. 1 and 2 show a method of coloring patterns or texts on a surface of a metal material according to the prior art. As shown in FIGS. 1 and 2, a surface treatment is first performed on an aluminum alloy material 1 to form a cladding layer 2 on a surface of the aluminum alloy material. The surface of the aluminum alloy material 1 appears the color of the cladding layer 2, as shown in FIG. 2b. Then, the patterns or texts 3, such as “ABC” in FIG. 2c are labeled by way of laser engraving. The laser engraving technology corresponds to a method of damaging the cladding layer on the surface of the workpiece. That is, the engraved and concave texts or patterns 3 appear the primary color of the aluminum alloy material 1. Thus, only one color can represent the to-be-labeled patterns or texts on the aluminum alloy material 1, and the patterns or texts are monotonous and lack of variations. In another method, the patterns or texts are labeled by attaching labels. However, the labels tend to detach so that the quality is poor, and the quality feeling and the aesthetic feeling of the workpiece are damaged. Alternatively, the patterns or texts may be directly printed on the surface of the workpiece. However, the printed patterns or texts tend to peel off, and the quality feeling and the aesthetic feeling of the workpiece are damaged. These drawbacks are to be solved in the industry.

Thus, it is an important subject of the invention to provide a method of coloring texts or patterns with multiple colors on the surface of the aluminum alloy material. The method can keep the surface flatness, increase the color variation and provide the utility. On the other hand, the intensity of the aluminum alloy material cannot be influenced, and the product quality may be enhanced.

### SUMMARY OF THE INVENTION

Thus, the invention provides a method of coloring patterns or texts on a surface of an aluminum alloy material. The method includes the steps of:

(a) performing an insulation treatment to form an insulating layer on the aluminum alloy material to be colored;

(b) forming the texts or patterns by way of laser engraving on the aluminum alloy material so that the insulating layer on the texts or patterns is removed;

(c) performing another insulation treatment to form another insulating layer on the texts or patterns so that the texts or patterns become non-conductive; and

(d) removing the another insulating layer from a portion of the texts or patterns to be colored with a first color, and coloring the portion of the texts or patterns by way of electro-deposition coating; and

(e) repeating the step (d) to color another portion of the texts or patterns by removing the another insulating layer on the another portion of the texts or patterns and by way of electro-deposition coating.

The effect of the invention is to form engraved texts or patterns with different colors on the surface of the aluminum alloy material. Thus, the patterns or texts have the rich color variation as compared with those with the single color. In addition, the engraved texts or patterns are formed by way of electro-deposition coating and coloring. Compared with the prior art, in which the labels are added, the texts or patterns are printed or the patterns or texts are engraved. So, the invention can provide the better quality feeling to the human.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a flow chart showing a method of coloring patterns or texts on a surface of a metal material according to the prior art.

FIG. 2 is a schematic illustration showing the method of coloring the patterns or the texts on the surface of the metal material of FIG. 1.

FIG. 3 is a flow chart showing a method of coloring patterns or texts on a surface of an aluminum alloy material according to the invention.

FIG. 4 is a schematic illustration showing various color patterns or texts formed on the surface of the aluminum alloy material according to the invention.

FIG. 5 shows a used state of coloring three colors on the patterns of the surface of the aluminum alloy material according to the invention.

FIG. 6 shows a used state of coloring three colors on the texts of the surface of the aluminum alloy material according to the invention.

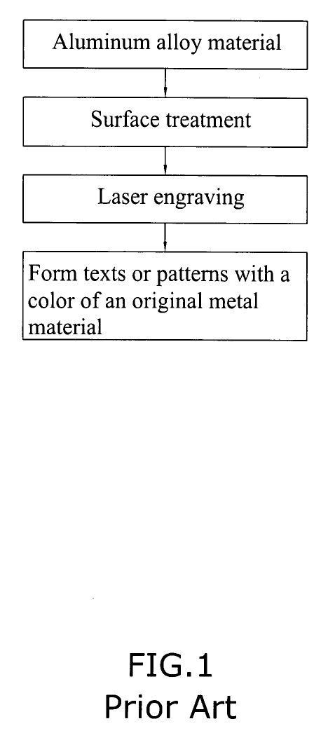

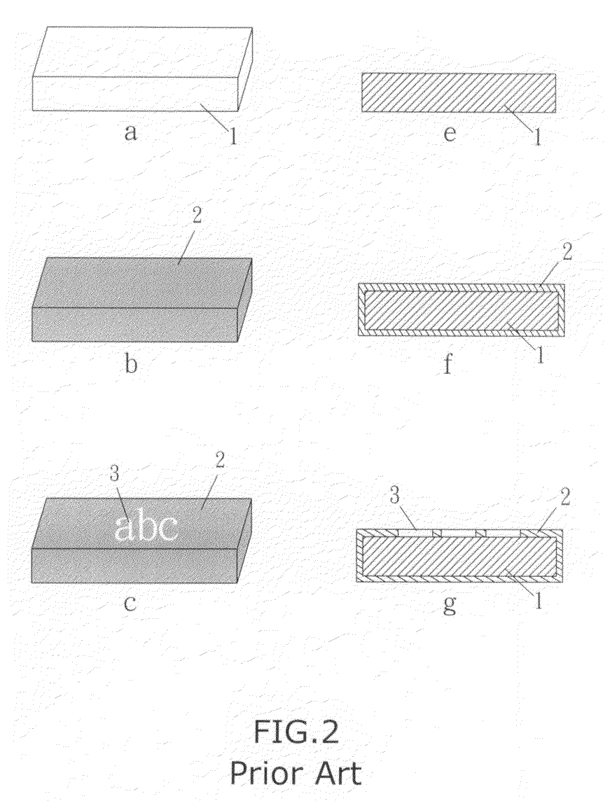

### DETAILED DESCRIPTION OF THE PREFERRED EMBODIMENTS

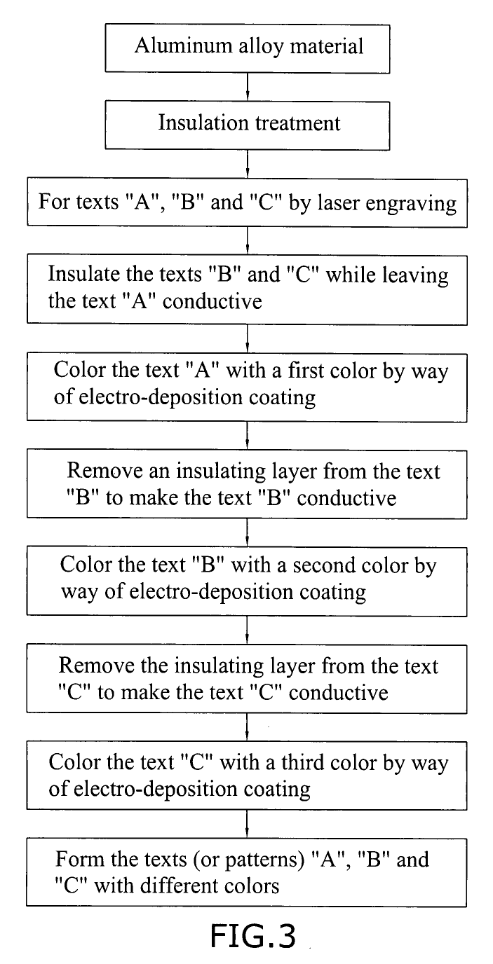

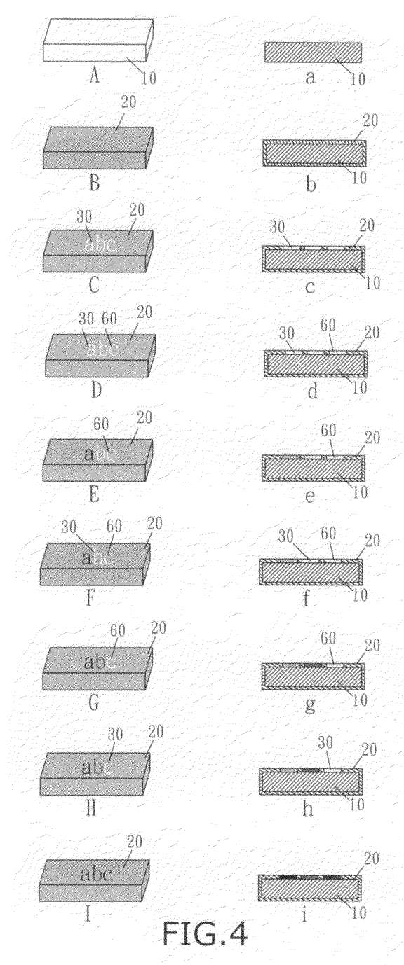

The method of coloring patterns or texts on a surface of an aluminum alloy material according to the invention will be described with reference to FIGS. 3 and 4. The method includes the following steps.

(a) First, an insulation treatment is performed on an aluminum alloy material 10 to form an insulating layer on the aluminum alloy material 10 to be colored. In this invention, the aluminum alloy material is insulated to become non-conductive by way of electro-deposition coating. Of course, the primary color of the aluminum alloy material may be changed, as shown in FIGS. 4a and 4b, because an insulating layer 20 is formed on the surface of the aluminum alloy material 10.

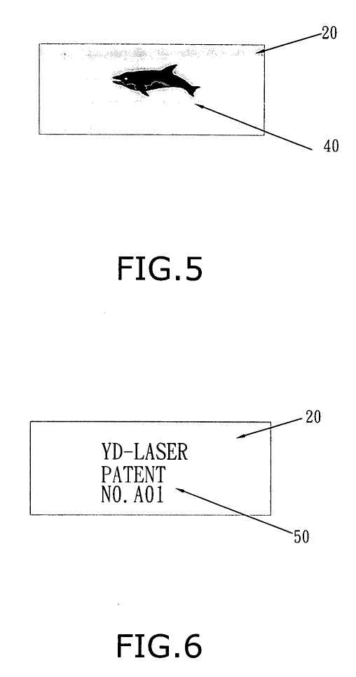

(b) The texts or patterns 30 are formed on the surface of the aluminum alloy material 10 by way of laser engraving, as indicated by the texts “A”, “B” and “C” in FIG. 4c, or a whale pattern 40 in FIG. 5. As shown in FIG. 6, three descriptive texts 50 are formed, and the texts or patterns 30 to 50 formed by way of laser engraving have damaged the insulating layer 20 on the surface of the aluminum alloy material 10. Thus, the portion of the texts or patterns 30, 40 or 50 becomes conductive since the insulating layer is removed. The texts or patterns may also be formed by way of sand blasting or CNC computer engraving. As shown in FIG. 4c, the engraved texts “A”, “B” and “C” appear the primary color of the aluminum alloy material 10. Thus, the texts or patterns 30, 40 or 50 may be colored with different colors by way of electro-deposition coating. Also, different colors may appear on the texts or patterns 30, 40 or 50, and this is the technological principle of this invention.

(c) The insulation treatment is performed on a larger portion of the engraved texts or patterns 30, 40 or 50 on the surface of the aluminum alloy material 10, and a smaller portion of the texts or patterns with the first color is not insulated. Typically, the insulation treatment is performed by applying an insulating paint to the texts or patterns 30, 40 or 50 so that the portion becomes non-conductive temporarily.

(d) A portions of the texts or patterns becomes non-conductive by applying the insulating paint, and another portion of the texts or patterns, which are not applied with the insulating paint, can be colored by way of electro-deposition coating. When the second color is to be colored, the insulating layer on the portion of the texts is removed so that the portion of the texts or patterns without the insulating layer becomes conductive. Then, the texts or patterns may be colored by way of electro-deposition coating.

(e) The step (d) is repeated so that the other texts or patterns can be colored by way of electro-deposition coating after the insulating layer is removed.

The method of coloring the texts 30 (A, B, C) with the different colors according to the embodiment of the invention will be illustrated in the following.

First, the insulating paint on the text “A” is kept, and the texts “B” and “C” are applied with the insulating paint 60 so that the texts “B” and “C” become non-conductive, as shown in FIG. 4d.

Second, the aluminum alloy material 10 is colored by way of electro-deposition coating. Because the text “A” of the texts 30 without the insulating paint is kept on the surface of the aluminum alloy material 10, the color paint can be coated on only the conductive text “A” so that the depressed text “A” may be formed and then the depressed text “A” may be full with the paint. Thus, the surface of the aluminum alloy material 10 may be kept smooth while appearing another color. In this way, the operation of coloring the texts 30 with the first color is completed, as shown in FIG. 4e. In this embodiment, the text “A” is shown in black).

Third, the text “B” is selected to be colored with the second color by way of electro-deposition coating after the insulating layer is removed. As shown in FIG. 4f, the insulating layer is removed from the text “B” of the texts 30 so that the text “B” becomes conductive and another coloring paint may be coated on the depressed text “B” while filling into the depressed text “B” to keep the surface of the aluminum alloy material 10 smooth and to appear the second color, as shown in FIG. 4g in red. After the second color is colored, the other text “C”, on which the insulating layer is not removed, is still non-conductive. So, the text “C” cannot be colored. The text “A” of the texts 30 after being colored by way of electro-deposition coating becomes non-conductive because the cladding layer has been formed on the text “A”. Thus, when the next process of coloring is performed by way of electro-deposition coating, the text “A” cannot be colored again.

Fourth, the third step is repeated to color the text “C” of the texts 30 with the third color. The insulating layer on the text “C” is removed, as shown in FIG. 4h. Then, the text “C” is colored by way of electro-deposition coating so that the text “C” of the texts 30 appears the third color, as shown in blue in FIG. 4l.

According to the above-mentioned steps, it is possible to form the texts 30 with the different colors on the surface of the aluminum alloy material 10, to form the whale pattern 40 with three colors in FIG. 5, or to form the texts 50 with three colors in FIG. 6. Thus, the surface of the aluminum alloy material 10 appears the rich color variations, the flatness and glorification of the surface of the aluminum alloy material 10 may be enhanced, and the prior art drawback of making the depressed pattern, which is formed by way of laser engraving and appears the primary color of the metal in a monotonous manner that is lack of variation, may be solved. Various color paints or dyes are coated on the texts or patterns 30 according to the electro-deposition coating technology in this invention so that the different colors may appear on the surface of the aluminum alloy material 10. Since the adhesive force of the paint or dye by way of electro-deposition coating is very strong and the surface flatness is good, the texts or patterns are garish for a long time and cannot peel off or the colors thereof cannot be changed. Thus, it is possible to eliminate the drawback caused in the prior art, in which the labels are attached or printed and tend to detach or peel off. Of course, the method of the invention may also be adopted to form one single color, such as black, red or blue, which is different from the primary color of the aluminum alloy material on the surface of the aluminum alloy material directly. If the black, red or blue portion has to be formed according to the prior art, the portion has to be printed on the product or a label has to be adhered to the portion. Thus, the invention is different from the prior art method, has the better quality and can enhance the quality and value of the product.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A method of coloring patterns or texts on a surface of an aluminum alloy material, the method comprising the steps of:
(a) performing an insulation treatment to form an insulating layer on the aluminum alloy material to be colored;
(b) forming the texts or patterns by way of laser engraving on the aluminum alloy material so that the insulating layer on the texts or patterns are removed;
(c) performing another insulation treatment to form another insulating layer on the texts or patterns so that the texts or patterns become non-conductive; and
(d) removing the another insulating layer from a portion of the texts or patterns to be colored with a first color, and coloring the portion of the texts or patterns by way of electro-deposition coating; and
(e) repeating the step (d) to color another portion of the texts or patterns by removing the another insulating layer on the another portion of the texts or patterns and by way of electro-deposition coating so that the texts or patterns with different colors may be formed on the surface of the aluminum alloy material, a flatness of the surface is kept, and a rich color variation and better quality feeling are provided.

2. The method according to claim 1, wherein the texts or patterns are formed by way of CNC computer engraving.

3. The method according to claim 1, wherein the texts or patterns are formed by way of sand blasting.
